(19) United States
(12) Patent Application Publication
(10) Pub. No.: US 2020/0206889 A1
(43) Pub. Date: Jul. 2, 2020

(54) HAND TOOL ASSEMBLY

(71) Applicant: Shou-Hung Chen, Taichung City (TW)

(72) Inventor: Shou-Hung Chen, Taichung City (TW)

(21) Appl. No.: 16/234,569

(22) Filed: Dec. 28, 2018

(51) Int. Cl. B25G 3/34; B25G 3/14; E04F 21/02

(52) U.S. Cl. CPC B25G 3/34; E04F 21/026; B25G 3/14

(57) ABSTRACT

A tool assembly includes a handle and a connection end which is connected to the handle by way of blow molding or ultra-sonic fusion. The connection end can be made by plastic injection molding. The handle can be made by way of blow molding. The connection end has a slot defined axially therein. A blade includes a body and a toothed portion. The toothed portion of the blade is connected to the slot of the connection end. The toothed portion is inserted into the slot of the connection end when the connection end is molded by way of blow molding so that the toothed portion of the blade is connected to the slot of the connection end. The toothed portion has multiple teeth and each tooth includes an inclined edge tapered toward the downward toward the connection end.

### BACKGROUND OF THE INVENTION

### 1. Fields of the Invention

The present invention is a divisional application of US Patent Application No. 15/393374, filed on Dec. 28, 2016.

### 2. Descriptions of Related Art

The conventional joint knife comprises a flexible blade with desired flex point for applying and smoothing compound and taping joints. The joint knife is ideal for spreading putty or joint compound. Generally, the blade is connected between two parts of the handle by a rivet.

However, the rivet tends to loose after being used, for a period of time, this is mostly because the rivet extends through the knife only and contacts the knife by a circle instead by a face. Lateral force pushes the rivet frequently to cause the rivet to be loosened. In addition, the two parts of the handle are made by wood which cannot securely and firmly connected to the blade.

Another joint knife is an integral product which includes a plastic handle integrally formed with the blade during the processes of molding. Nevertheless, the handle has to be thick enough so as to provide a comfort griping feature to the users, the thicker the handle is, the longer time required to be cooled after molding. This makes the manufacturing cost be higher than other types of joint knives.

For those joint knives that require the blade directly connected with the handle, the connection becomes a main concern for the manufacturers. The blades are put in the molding set after they are polished, and the polished surface of the blades may be damaged by the molding set. Furthermore, the molding set for the conventional joint knives has to be cooled down quickly to accelerate efficiency of production, and the cooling agent is water, unfortunately, water may cause rusting to the blades.

The present invention intends to provide a hand tool assembly that eliminates the shortcomings mentioned above.

### SUMMARY OF THE INVENTION

The present invention relates to a tool assembly and comprises a handle and a connection end which is connected to the handle by way of blow molding or ultra-sonic fusion. Alternatively, the connection end can be made by plastic injection molding, and the handle can be made by way of blow molding. The connection end has a slot defined axially therein. A blade includes a body and a toothed portion. The toothed portion of the blade is connected to the slot of the connection end. The toothed portion is inserted into the slot of the connection end when the connection end is molded by way of blow molding so that the toothed portion of the blade is connected to the slot of the connection end, The toothed portion has multiple teeth and each tooth includes an inclined edge tapered toward the downward toward the connection end.

Preferably, the toothed portion has multiple teeth and each tooth includes an inclined edge tapered toward the downward toward the connection end.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hand tool assembly of the present invention;

FIG. 2 is an enlarged cross sectional view to show the connection between the handle, the connection end and the blade of the hand tool assembly of the present invention;

FIG. 3 is an exploded view of the second embodiment of the hand tool assembly of the present invention;

FIG. 4 is an enlarged cross sectional view to show the connection between the handle, the connection end and the blade of the second embodiment of the hand tool assembly of the present invention;

FIG. 5 is an exploded and cross sectional view of the third embodiment of the hand tool assembly of the present invention;

FIG. 6 is an enlarged cross sectional view to show the connection between the handle, the connection end and the blade of the third embodiment of the hand tool assembly of the present invention;

FIG. 7 is a perspective view to show the hand tool assembly of the fourth embodiment of the present invention, and

FIG. 8 is an enlarged cross sectional view to show the connection between the handle, the connection end and the blade of the fourth embodiment of the hand tool assembly of the present invention.

### DETAILED DESCRIPTION OF THE PREFERRED EMBODIMENT

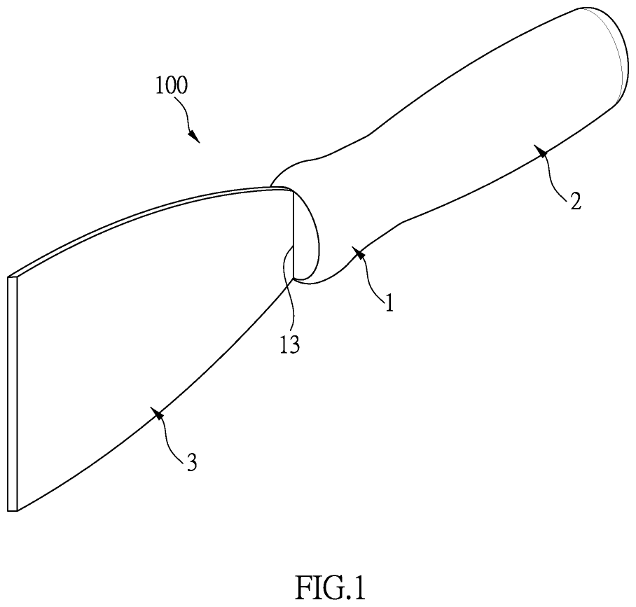

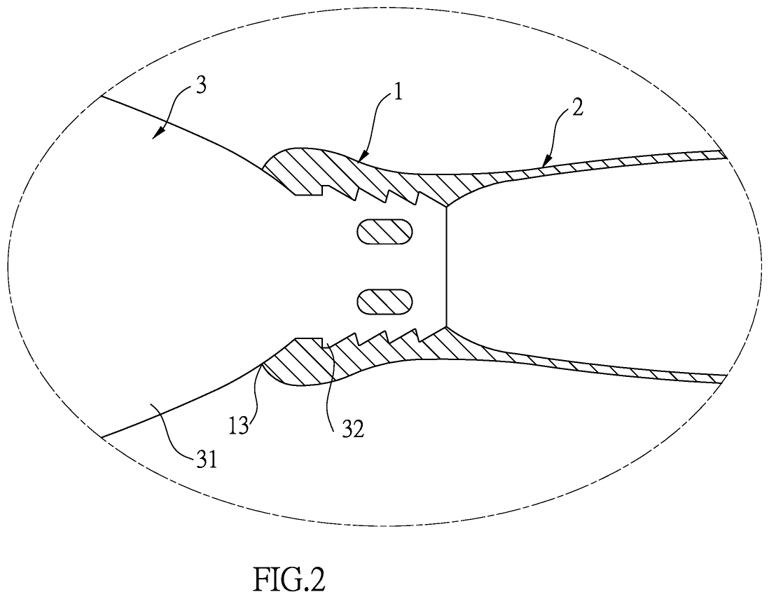

Referring to FIGS. 1 and 2, the first embodiment of the hand tool assembly 100 of the present invention comprises a connection end 1, a handle 2 and a blade 3. The handle 2 and the connection end 1 are made by way of blow molding. The connection end 1 has a slot 13 defined axially therein which is formed during the processes of blow molding. The blade 3 has a body 31 and a toothed portion 32. The toothed portion 32 of the blade 3 is connected to the slot 13 of the connection end 1. Specifically, the toothed portion 32 has multiple teeth and each tooth includes an inclined edge tapered toward the downward toward the connection end 1. The toothed portion 32 is inserted into the slot 1 of the connection end 1 when the connection end 1 is molded by way of blow molding so that the toothed portion 32 of the blade 3 is connected to the slot 13 of the connection end 1. A chuck (not shown) is used to clamp the connection end 1 and the toothed portion of the blade 3, and the chuck is removed after the hand tool assembly is cooled down. Therefore, the toothed portion 32 is integrally connected to the inside of the slot 13. The hand tool assembly 100 saves plastic material because the handle 2 and the connection end 1 are made by way of blow molding. The connection between the connection end 1 and the toothed portion 32 of the blade 3 is secured.

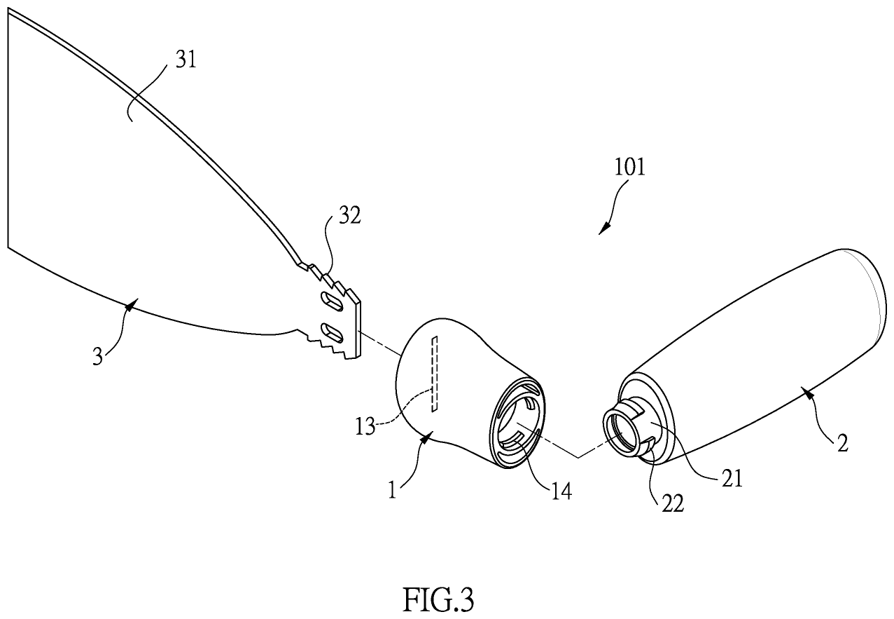

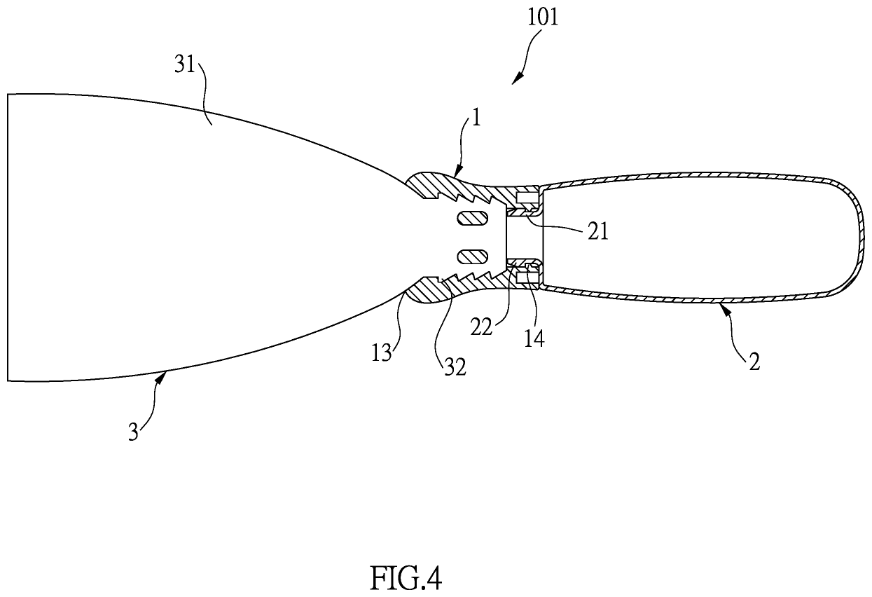

As shown in FIGS. 3 and 4, the second embodiment of the tool assembly of the present invention is disclosed, wherein the tool assembly 101 comprises a handle 2 which is made by way of blow molding, and the connection end 1 is made by way of plastic injection molding.

The handle 2 has a protrusion 21 extending axially from one end thereof, and the protrusion 21 having a hooked portion 22 formed on the outer periphery thereof

The connection end 1 includes a slot 13 defined axially in the first end thereof, and the second end of the connection end 1 is an open end. At least one rib 14 extends inward from the inner periphery of the open end of the connection end 1. In this embodiment, there are two ribs 14. The protrusion 21 of the handle 2 is inserted into the second end of the connection end 1 and the ribs 14 are engaged with the hooked portion 22.

A blade 3 has a body 31 and a toothed portion 32, wherein the toothed portion 32 of the blade 3 is connected to the slot 13 of the connection end 1. The toothed portion 32 has multiple teeth and each tooth includes an inclined edge tapered toward the downward toward the connection end 1.

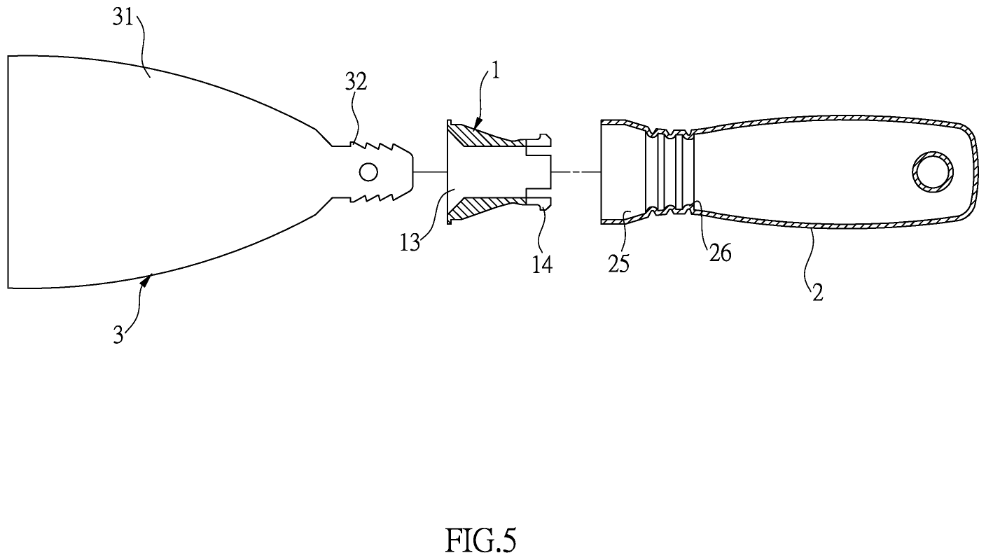

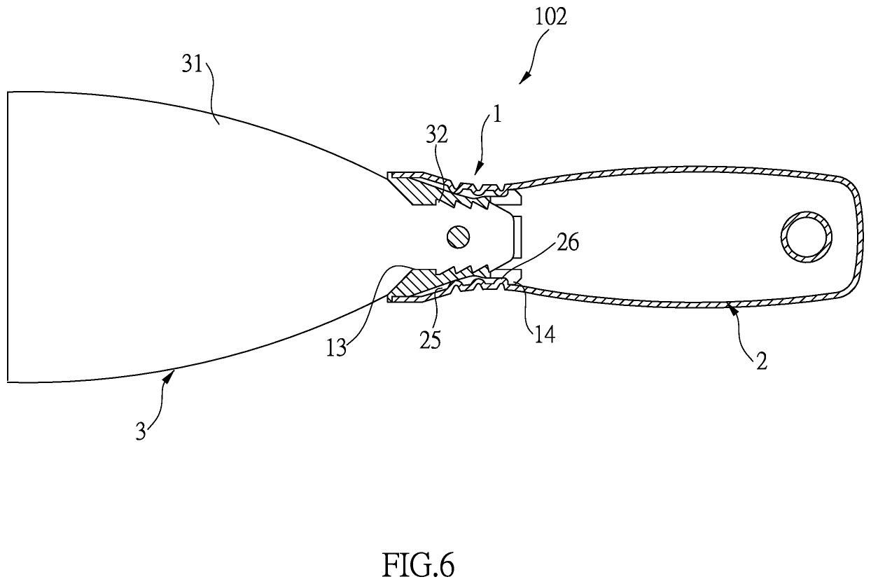

As shown in FIGS. 5 and 6, the third embodiment of the tool assembly of the present invention is disclosed, wherein the tool assembly 102 comprises a handle 2 which is made by way of blow molding, and the connection end 1 is made by way of plastic injection molding. The handle 2 and the connection end 1 are made separately. The handle 2 has a room 25 defined in one end thereof. A grooved portion 26 formed in the inner periphery of the room 25. The connection end 1 includes a slot 13 defined axially in the first end thereof At least one rib 14 extends from the second end of the connection end 1. in this embodiment, there are two ribs 14. The second end of the connection end 1 is inserted into the room 25 of the handle 2 and the ribs 14 are engaged with the grooved portion 26 of the handle 2.

A blade 3 has a body 31 and a toothed portion 32. The toothed portion 32 of the blade 3 is connected to the slot 13 of the connection end 1. The toothed portion 32 has multiple teeth and each tooth includes an inclined edge tapered toward the downward toward the connection end 1.

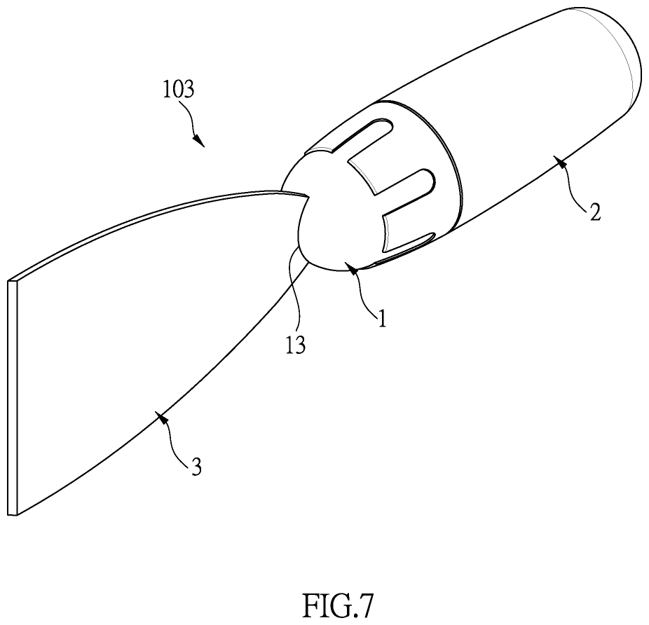

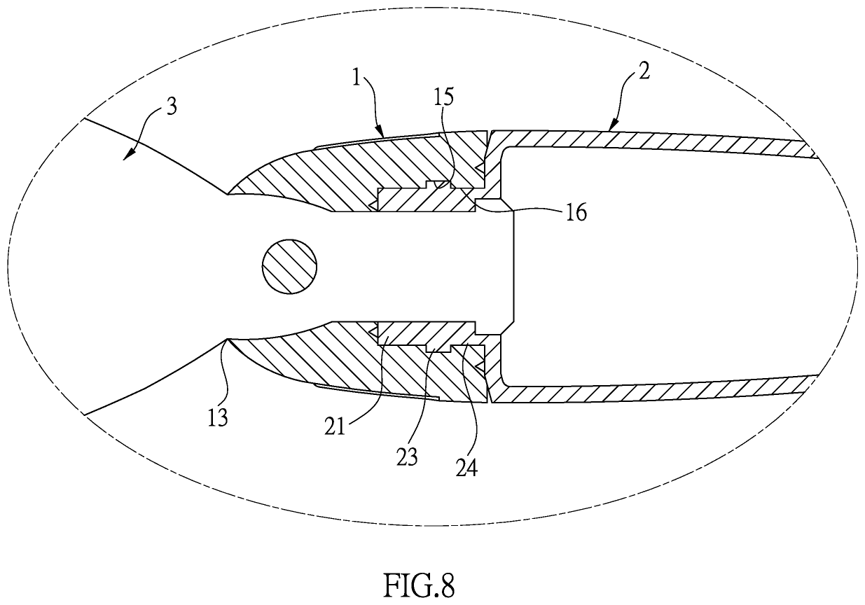

As shown in FIGS. 7 and 8, the fourth embodiment of the tool assembly 103 of the present invention is disclosed, wherein the handle 2 is connected to the connection end 1 by way of ultra-sound fusion. The connection end 1 has a slot 13 defined axially in the first end thereof, and the second end of the connection end 1 is an open end. A first groove 15 and a first flange 16 are formed in the inner periphery of the second end of the connection end 1. The first flange 16 is located close to the handle 2 and the first groove 15 located away from the handle 2. The handle 2 has a protrusion 21 extending axially from one end thereof. A second flange 23 and a second groove 24 are formed on the outer periphery of the protrusion 21. The protrusion 21 of the handle 2 is inserted into the second end of the connection end 1. The first groove 15 engaged with the second flange 23, and the first flange 16 is engaged with the second groove 24. The hand tool assembly of the present invention is easily to make and saves plastic material. The connection between the blade 3. the connection end 1 and the handle 2 is secured so that the blade 3 does not disengaged from the connection end 1 or the handle 2 even if the blade 3 is applied by a large force.

While we have shown and described the embodiment in accordance with the present invention, it should be clear to those skilled in the art that further embodiments may be made without departing from the scope of the present invention.

What is claimed is:

1. A tool assembly comprising:
a handle being made by way of blow molding, the handle having a protrusion extending axially from one end thereof, the protrusion having a hooked portion formed on an outer periphery thereof;
a connection end made by way of plastic injection molding and having a slot defined axially in a first end thereof, a second end of the connection end being an open end, at least one rib extending inward from an inner periphery of the open end of the connection end, the protrusion of the handle inserted into the second end of the connection end and the at least one rib engaged with the hooked portion, and
a blade having a body and a toothed portion, the toothed portion of the blade connected to the slot of the connection end.

2. The tool assembly as claimed in claim 1, wherein the toothed portion has multiple teeth and each tooth includes an inclined edge tapered toward the downward toward the connection end.
